(19) United States
(12) Patent Application Publication
(10) Pub. No.: US 2022/0395857 A1
(43) Pub. Date: Dec. 15, 2022

(54) POWDER COATING DEVICE AND POWDER COATING METHOD

(71) Applicant: HONDA MOTOR CO., LTD., Tokyo (JP)

(72) Inventors: Kenji MASAI, Tokyo (JP); Muneki YAMADA, Tokyo (JP); Hiroaki MATSUMOTO, Tokyo (JP)

(21) Appl. No.: 17/659,846

(22) Filed: Apr. 20, 2022

(30) Foreign Application Priority Data
Jun. 10, 2021 (JP) 2021-097220

(51) Int. Cl. B05D 1/24; B05C 19/02; B05C 3/05

(52) U.S. Cl. CPC B05D 1/24; B05C 19/02; B05C 3/05

(57) ABSTRACT

Provided is a powder coating device including a powder fluidization tank including a bottom member, a fixing member to which the powder fluidization tank is fixed, a coupling support member coupling and supporting the bottom member to the fixing member, and a vibration mechanism coupled to the bottom member, wherein the coupling support member includes a rubber laminate in which an elastic member and a rigid member are stacked, and is pressed by the bottom member and the fixing member.

This application is based on and claims the benefit of priority from Japanese Patent Application No. 2021-097220, filed on 10 Jun. 2021, the content of which is incorporated herein by reference.

### BACKGROUND OF THE INVENTION

### Field of the Invention

The present invention relates to a powder coating device and a powder coating method.

### Related Art

Conventionally, when coating insulating powder onto a coil end of a stator which is a component of a motor installed in a vehicle, a fluidized bed coating process is used.

Patent Document 1 discloses a powder resin coating device including a powder fluidization tank having a first partition plate and a second partition plate as porous plates, a vibration mechanism connected to a bottom surface of the powder fluidization tank, and a support member connecting the powder fluidization tank and a fixing surface, wherein the support member elastically supports the powder fluidization tank to the fixing surface.
Patent Document 1: Japanese Patent No. 6596477

### SUMMARY OF THE INVENTION

However, as illustrated in FIG. 1, as a distance in a Y-axis direction (horizontal direction) from the axis line of the powder coating device increases, the amplitude and the acceleration in a Z-axis direction (axis line direction) also increases. This results in a large difference in blockage rate between pores at the central portion and at the outer peripheral portion of the second partition plate, causing a radial flow in the powder surface. This may cause a boundary between a coated area and an uncoated area to become diffuse. The amplitude and the acceleration can be measured using a sensor at a predetermined frequency and a predetermined excitation force.

The present invention has an object of providing a powder coating device capable of suppressing the occurrence of radial flow in the powder surface.

According to an aspect of the present invention, a powder coating device includes: a powder fluidization tank including a bottom member; a fixing member to which the powder fluidization tank is fixed; a coupling support member coupling and supporting the bottom member to the fixing member; and a vibrator coupled to the bottom member, wherein the coupling support member includes a rubber laminate having an elastic member and a rigid member that are stacked on each other, and is pressed by the bottom member and the fixing member.

The elastic member may include a rubber member.

The rigid member may include a metal member.

The vibrator may include a vibrator body and a coupler coupling the vibrator body to the bottom member, and the vibrator body may include a vibration motor having an eccentric rotation shaft.

According to another aspect of the present invention, a powder coating method includes a step of coating a workpiece with a resin powder using the powder coating device described above.

According to the present invention, it is possible to provide a powder coating device capable of suppressing the occurrence of radial flow in the powder surface.

### BRIEF DESCRIPTION OF THE DRAWINGS

FIG. 1 illustrates measurement results of amplitude and acceleration distribution in a powder fluidization tank of a conventional powder coating device;

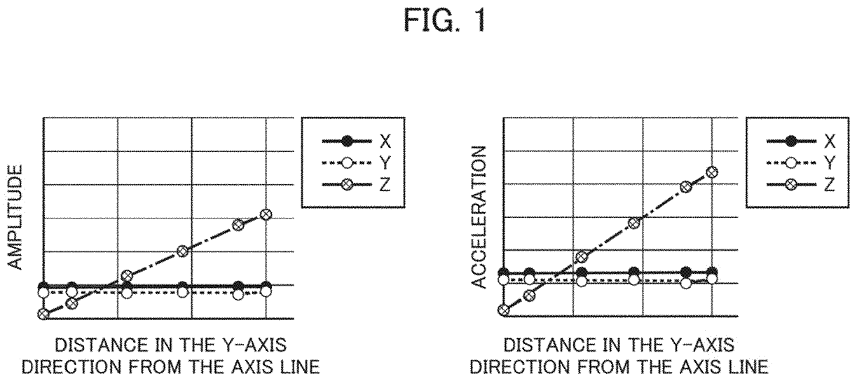

FIG. 2 illustrates an example of a powder coating device according to an embodiment of the present invention;

FIG. 3 illustrates a powder fluidization tank and a stand of the powder coating device of FIG. 2;

FIG. 4 illustrates an example of a coupling support member of FIG. 2;

FIG. 5 illustrates measurement results of amplitude and acceleration distribution in the powder fluidization tank of the powder coating device of FIG. 2; and

FIG. 6 illustrates a state of a powder surface in the powder fluidization tank of the powder coating device of FIG. 2.

### DETAILED DESCRIPTION OF THE INVENTION

An embodiment of the present invention is described below with reference to the drawings.

### [Powder Coating Device]

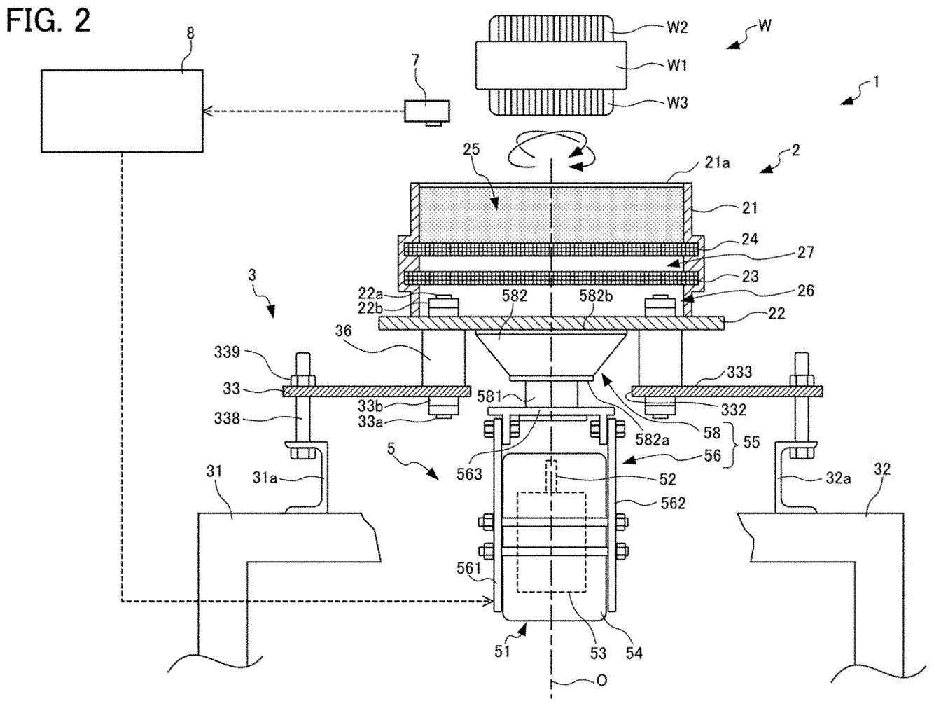

FIG. 2 illustrates an example of a powder coating device according to the present embodiment.

A powder coating device 1 coats a workpiece with a resin powder using a fluidized bed coating process. The powder coating device 1 includes a powder fluidization tank 2, a stand 3 that supports the powder fluidization tank 2 on a placement surface, a vibration mechanism 5 coupled to a bottom plate 22 of the powder fluidization tank 2, a level meter 7 that detects a powder surface height in the powder fluidization tank 2, and a control device 8 that controls the vibration mechanism 5.

Described below is a case in which a stator W which is a component of a motor installed in a vehicle is used as the workpiece and an insulating powder is used as a resin powder. However, the workpiece and the resin powder are not so limited. Resins that may constitute the insulating powder include, for example, epoxy resin, etc.

The stator W includes a cylindrical stator core W1 and a stator coil W2 wound in a plurality of slots formed inside the stator core W1. Here, a lower end of the stator coil W2 is a coil end W3 to be coated with insulating powder.

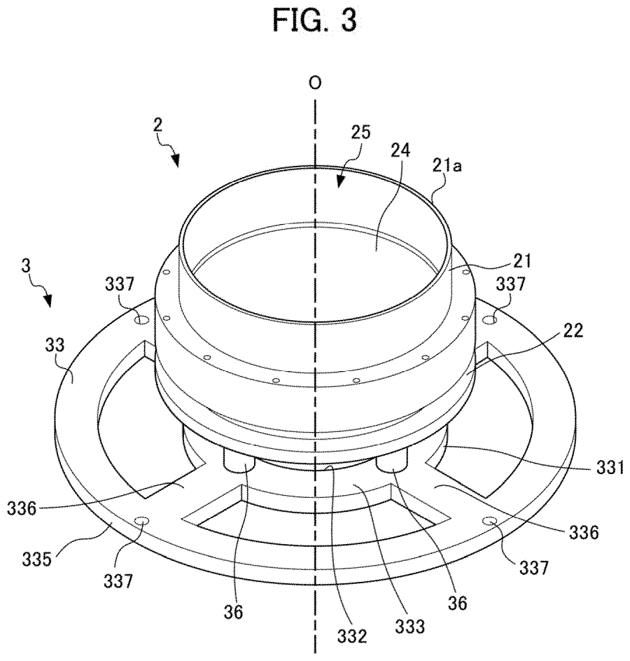

FIG. 3 illustrates the powder fluidization tank 2 and the stand 3 of the powder coating device 1.

The powder fluidization tank 2 is approximately circular in a top view. The powder fluidization tank 2 includes a cylindrical trunk 21, an approximately disc-shaped bottom plate 22, a first partition plate 23 and a second partition plate 24 that are approximately disc-shaped and provided inside of the trunk 21, and a powder storage unit 25 where insulating powder is stored. Here, the bottom plate 22 is provided with a bolt. 22a, and by tightening a nut 22b, the bottom plate 22 and a fixed plate 33 press against a coupling support member 36. In addition, the first partition plate 23 and the second partition plate 24 are porous plates in which there are formed through holes each having a diameter smaller than the particle size of the insulating powder.

The powder storage unit 25 is defined by an edge part 21a of the trunk 21 and the second partition plate 24. In addition, a first air chamber 26 is formed by the space demarcated by the bottom plate 22 and the first partition plate 23, and a second air chamber 27 is formed by the space demarcated by the first partition plate 23 and the second partition plate 24. In addition, the first air chamber 26 is supplied with air at a predetermined rate from an air supply device. The air supplied into the first air chamber 26 flows into the second air chamber 27 via the first partition plate 23, then flows into the powder storage unit 25 via the second partition plate 24. As a result, the insulating powder stored inside the powder storage unit 25 fluidizes.

The stand 3 includes a plurality of fixed frames 31 and 32, a fixed plate 33, and a plurality of coupling support members 36 coupling and supporting the bottom plate 22 to the fixed plate 33. Here, four coupling support members 36 are provided on the side of an axis line O with respect to the trunk 21, and the four coupling support members 36 are arranged at equal intervals.

The lower ends of the fixed frames 31, 32 are respectively fixed to installation surfaces.

The fixed plate 33 is substantially disc-shaped in a top view, and is provided substantially coaxially with the axis line O. Here, the fixed plate 33 is provided with a bolt 33a, and by tightening a nut 33b, the bottom plate 22 and the fixed plate 33 press against the coupling support member 36. In addition, the fixed plate 33 includes an annular small-diameter plate 331 having a diameter substantially equal to that of the powder fluidization tank 2, a large-diameter plate 335 having a diameter larger than that of the small-diameter plate 331, and connection plates 336 which connect the small-diameter plate 331 to the large-diameter plate 335. A through hole 332 for inserting the vibration mechanism 5 is formed in the small-diameter plate 331. In addition, a plurality of through holes 337 are formed in the large-diameter plate 335 in order to fix the large-diameter plate 335 to the fixed frames 31 and 32 using nuts and bolts.

The fixed frames 31 and 32 respectively have, formed at the upper ends thereof, fixing parts 31a and 32a, and in the upper ends of the fixing parts 31a and 32a are formed through holes for fixing the fixed plate 33 using nuts and bolts.

The fixed plate 33 is fixed to the fixing parts 31a and 32a by bolts 338 and nuts 339, such that a fixing surface 333 of the small-diameter plate 331 on the side fixing the powder fluidization tank 2 becomes horizontal.

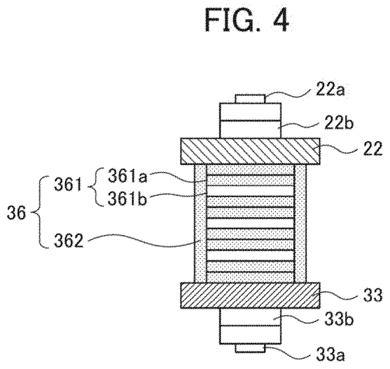

As illustrated in FIG. 4, the coupling support member 36 includes a rubber laminate 361 that includes four layers each constituted by two rubber plates 361a, and stainless steel plates 361b each sandwiched between the layers. This suppresses bulging in the horizontal direction or significant deformation in the vertical direction, which may occur when a vertical load is applied to a rubber-only structure. In this way, the stainless steel plates 361b restrain bulging deformation, and therefore displacement in the Z-axis direction (axis line direction) of the powder fluidization tank 2 is suppressed. Further, when a horizontal load is applied, a flexible spring action is created.

In addition, the coupling support member 36 is reinforced by winding a rubber material 362 around a side peripheral surface of the rubber laminate 361. Here, by tightening the nuts 22b and 33b the coupling support member 36 is pressed by the bottom plate 22 and the fixed plate 33.

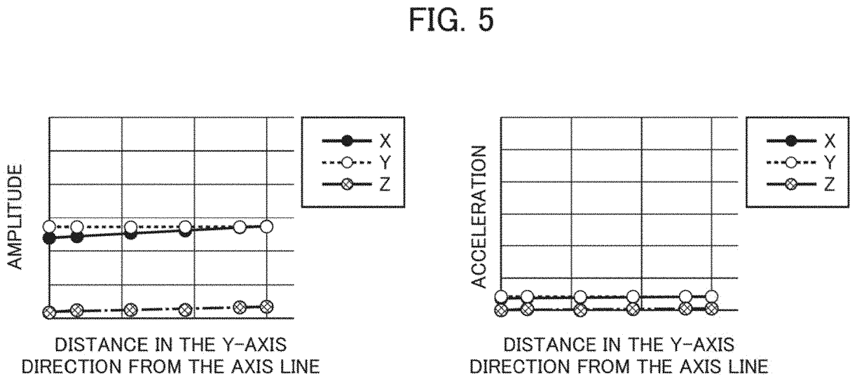

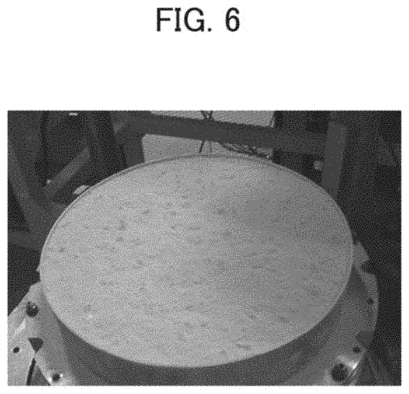

Using a sensor mounted to the edge part 21a of the trunk 21 to measure the amplitude and the acceleration with a predetermined frequency and a predetermined excitation force, the amplitude and the acceleration in the Z-axis direction (axis line O direction) are not high, even if the distance from the axis line O of the powder coating device 1 in the Y-axis direction (horizontal direction) is great, as illustrated in FIG. 5. This results in a smaller difference in blockage rate between pores at the central portion and at the outer peripheral portion of the second partition plate 24, so that, as illustrated in FIG. 6, radial flow does not occur in the powder surface at a predetermined air supply rate and a predetermined frequency of a vibration motor 53. In addition, the amplitude in the X-axis direction and the Y-axis direction (horizontal directions) is large, and therefore the insulating powder can be sufficiently fluidized.

The shapes of the rubber plate 361a and the stainless steel plate 361b are not particularly limited, and may include, for example, circular plates, polygonal plates, etc.

The rubber laminate 361 may be formed by, for example, using rubber plates whose surfaces exhibit improved adhesive properties when heated as the rubber plates 361a, or by applying an adhesive between each of the plates to be stacked.

It should be noted that the coupling support member 36 is not particularly limited, so long as it includes a rubber laminate in which an elastic member and a rigid member are stacked. As the material constituting the rigid member, a hardened resin, etc. may be substituted for stainless steel, and the rubber material 362 may be omitted. In addition, the number of coupling support members 36 is not particularly limited, nor is the number of elastic members and rigid members constituting the coupling support member 36.

The vibration mechanism 5 includes a vibration unit 51 serving as a columnar vibrator body, and a coupling mechanism 55 that couples the vibration unit 51 to the bottom plate 22.

The vibration unit 51 includes a vibration motor 53 having a rotation shaft 52, and a housing 54 which houses the vibration motor 53. The vibration motor 53 causes the rotation shaft 52 to rotate at a frequency according to a control signal from the control device 8. The housing 54 is coupled to the bottom plate 22 via the coupling mechanism 55 so as to become substantially coaxial with the axis line O of the powder fluidization tank 2. In addition, an eccentric weight is attached to the rotation shaft 52. Therefore, when the eccentric rotation shaft 52 is caused to rotate by the vibration motor 53, the housing 54 vibrates. At this time, the housing 54 vibrates such that a center point thereof makes a circular motion centered about the axis line O, within a horizontal plane perpendicular to the axis line O.

The coupling mechanism 55 includes a bracket 56 that retains the housing 54, and a coupling member 58 that is substantially coaxial with the axis line O and couples the bracket 56 to the bottom plate 22.

The bracket 56 includes a first support plate 561 and a second support plate 562 which are parallel to each other and are parallel to the axis line O, and a third support plate 563 that connects the first support plate 561 and the second support plate 562 and is perpendicular to the axis line O. The first support plate 561 and the second support plate 562 are respectively connected to opposing sides of the housing 54. In addition, the distances from the rotation shaft 52 to the first support plate 561 and to the second support plate 562 are equal. In other words, the housing 54 is sandwiched equally by the first support plate 561 and the second support plate 562, centered about the rotation shaft 52. In addition, the housing 54 is retained by the bracket 56 so as to be positioned below the fixed plate 33.

The coupling member 58 includes a shaft part 581 and a coupling part 582 which are substantially coaxial with the axis line O, and couples the bracket 56 provided below the fixed plate 33 to the bottom plate 22 provided above the fixed plate 33. The coupling part 582 is of a truncated cone shape, and expands in diameter towards a circular top surface 582b on the bottom plate 22 side from a circular bottom surface 582a on the bracket 56 side. The lower end side of the shaft part 581 is fixed to the third support plate 563 of the bracket 56, and the upper end side is fixed to the coupling part 582. In addition, the upper end side of the coupling part 582 is fixed to the bottom plate 22.

The outer diameter of the circular top surface 582b of the coupling part 582 is smaller than the inner diameter of the through hole 332 formed in the small-diameter plate 331 of the fixed plate 33, and the coupling part 58 will thus not contact the fixed plate 33 even when the housing 54 vibrates. Therefore, vibrations occurring in the housing 54 transmit to the powder fluidization tank 2 via the bracket 56 and the coupling part 58 without being dampened by the fixed plate 33.

The level meter 7 is provided above the powder fluidization tank 2. The level meter 7 detects the height of a powder surface in the powder fluidization tank 2 based on, for example, a triangulation method, and sends a signal according to the detected value to the control device 8. Here, the height of the powder surface is a distance from a predetermined reference (for example, the edge part 21a of the trunk 21). At this time, the level meter 7 transmits a laser beam from a light source towards a measurement position, and measures the height of the powder surface based on the position at which the laser beam reflected by the powder surface images on a photodetector.

The control device 8 determines a target for the air supply rate of the air supply device and a target for the frequency of the vibration motor 53 according to a predetermined program, and drives the air supply device and the vibration motor 53 so that these targets are realized.

### [Powder Coating Method]

A powder coating method according to the present embodiment includes a step of coating a workpiece with a resin powder using the powder coating device according to the present embodiment.

A case of forming an insulating layer on the coil end W3 of the stator W is described below.

The powder coating method according to the present embodiment includes a heating step of heating the stator W, a powder coating step of coating an insulating powder onto the coil end W3 of the stator W using the powder coating device 1, and a reheating step of reheating the stator W having the coil end W3 coated with the insulating powder.

In the heating step, the stator W is heated to a temperature that enables the coil end W3 to fuse the insulating powder.

In the powder coating step, the coil end W3 of the heated stator W is immersed in the powder fluidization tank 2 in which the insulating powder is flowing, and insulating powder is fused onto the coil end W3.

In the reheating step, after removing the stator W having insulating powder fused onto the coil end W3 from the powder fluidization tank 2, the stator W is reheated to form an insulating layer on the coil end W3.

An embodiment of the present invention has been described above, but the present invention is not to be limited thereto. The above embodiment may be modified as appropriate within the scope of the gist of the present invention.

### EXPLANATION OF REFERENCE NUMERALS

1 Powder coating device
2 Powder fluidization tank
22 Bottom plate
3 Stand
33 Fixed plate
36 Coupling support member
361 Rubber laminate
361a Rubber plate
361b Stainless steel plate
362 Rubber material
5 Vibration mechanism

What is claimed is:

1. A powder coating device comprising: a powder fluidization tank including a bottom member;
a fixing member to which the powder fluidization tank is fixed;
a coupling support member coupling and supporting the bottom member to the fixing member; and
a vibrator coupled to the bottom member,
wherein the coupling support member comprises a rubber laminate including an elastic member and a rigid member that are stacked on each other, and is pressed by the bottom member and the fixing member.

2. The powder coating device according to claim 1, wherein the elastic member comprises a rubber member.

3. The powder coating device according to claim 1, wherein the rigid member comprises a metal member.

4. The powder coating device according to claim 1, wherein the vibrator comprises a vibrator body and a coupler coupling the vibrator body to the bottom member,
the vibrator body including a vibration motor having an eccentric rotation shaft.

5. A powder coating method comprising coating a workpiece with a resin powder using the powder coating device according to claim 1.
